(19) United States
(12) Patent Application Publication
(10) Pub. No.: US 2017/0045659 A1
(43) Pub. Date: Feb. 16, 2017

(54) HUD IMAGE ENHANCEMENT LENS

(71) Applicant: Panasonic Automotive Systems Company of America, Division of Panasonic Corporation of North America, PEACHTREE CITY, GA (US)

(72) Inventor: DAVID K. LAMBERT, STERLING HEIGHTS, MI (US)

(73) Assignee: Panasonic Automotive Systems Company of America, Division of Panasonic Corporation of North America

(21) Appl. No.: 15/229,349

(22) Filed: Aug. 5, 2016

Related U.S. Application Data
(60) Provisional application No. 62/205,116, filed on Aug. 14, 2015.

(51) Int. Cl. G02B 5/30; G02B 27/01

(52) U.S. Cl. CPC G02B 5/3083; G02B 27/0101

(57) ABSTRACT

A vehicle includes a heads up display module emitting polarized light. A windshield reflects the polarized light toward a driver of the vehicle. A lens clips onto polarizing eyeglasses worn by the driver. The lens includes a waveplate.

### FIELD OF THE INVENTION

The disclosure relates to the field of eye glasses, and, more particularly, to a pair of lenses that may be clipped-on a pair of eye glasses.

### BACKGROUND OF THE INVENTION

It is known for heads-up displays (HUDs) to be provided in association with a vehicle's front windshield. Conventional HUDs use reflection from the inner and outer surfaces of the windshield to create an image that, as seen by the driver, is composed of almost completely polarized light. It is common for drivers to wear polarizing sunglasses. The sunglasses are designed with polarizers oriented to block glare from water on the road. Unfortunately, this also blocks the HUD image that reflects from the windshield. The current practice is to advise the driver not to use polarizing sunglasses with a HUD, or to make do with the small fraction of light from the HUD that is passed by the sunglasses.

### SUMMARY

The present invention may provide a pair of lenses each of which clips over a respective one of the two lenses of polarizing sunglasses to enable a driver wearing the sunglasses to more easily see the image from a conventional heads up display (HUD). Each inventive lens may contain a waveplate which may be fastened over the respective polarizing lens of the sunglasses to increase the amount of light from the HUD that the driver sees.

In one embodiment, the invention comprises a vehicle including a heads up display module emitting polarized light. A windshield reflects the polarized light toward a driver of the vehicle. A lens clips onto polarizing eyeglasses worn by the driver. The lens includes a waveplate.

In another embodiment, the invention comprises an automotive display method, including providing a vehicle with a heads up display. Polarized light is emitted from the heads up display. The polarized light is reflected off of a windshield and toward a driver of the vehicle. The driver is provided with a lens configured to clip onto polarizing eyeglasses worn by the driver. The lens includes a waveplate.

In yet another embodiment, the invention includes a vehicle having a heads up display module emitting polarized light. A windshield reflects the polarized light toward a driver of the vehicle. A lens is attached to polarizing eyeglasses worn by the driver. The lens includes a waveplate having an axis that is oriented at an angle of approximately between 35 degrees and 55 degrees relative to a vertical direction.

The invention may have the advantage that the driver may better see the display produced by a HUD.

### BRIEF DESCRIPTION OF THE DRAWINGS

A better understanding of the present invention will be had upon reference to the following description in conjunction with the accompanying drawings.

FIG. 1a is a side schematic view of one embodiment of a HUD image enhancement lens arrangement of the present invention.

FIG. 1b is a schematic plan view of the clip-on lens of the arrangement of FIG. 1a.

FIG. 2 is a flow chart of one embodiment of an automotive display method of the present invention.

### DETAILED DESCRIPTION OF THE PREFERRED EMBODIMENTS

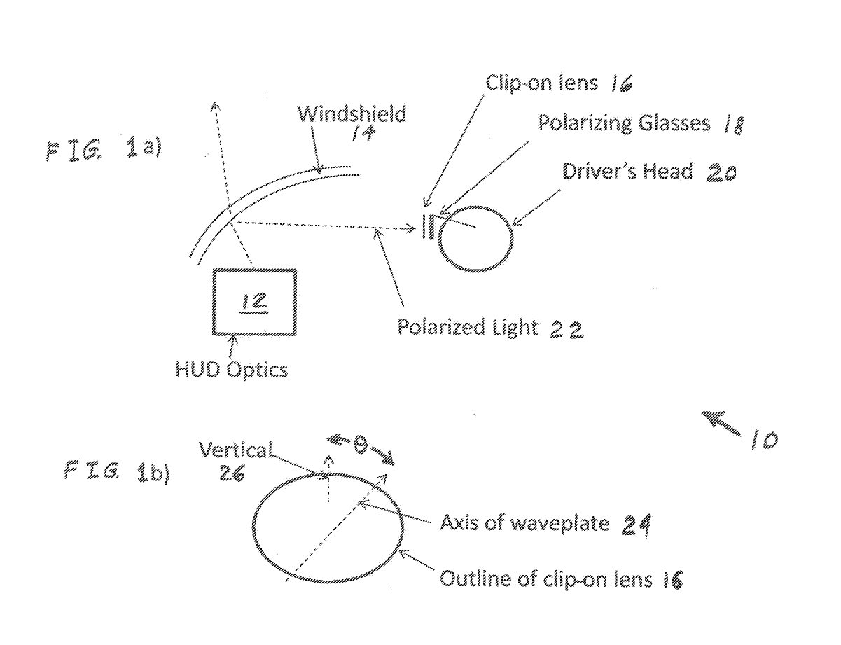

FIG. 1a illustrates one embodiment of a HUD image enhancement lens arrangement 10 of the present invention, including a HUD optics module 12, a windshield 14, a clip-on lens 16, and polarizing eyeglasses 18 worn on a driver's head 20. There may be two clip-on lenses 16, a respective one for each of two polarizing lenses of eyeglasses 18.

During use, polarized light 22 from HUD optics module 12 is incident to the driver 20, the polarized sunglasses 18, and the clip-on lens 16. Lens 16 contains a waveplate and is clipped over the sunglasses 18. The waveplate may alter the polarization state of the polarized light 22 travelling through the waveplate. The waveplate may be a half-wave plate, which shifts the polarization direction of linearly polarized light, or a quarter-wave plate, which converts linearly polarized light into circularly polarized light and vice versa. A quarter wave plate can be used to produce elliptical polarization as well.

As shown in FIG. 1b, an axis 24 of the waveplate may be oriented at an angle θ of approximately 45 degrees from a vertical direction 26. If the waveplate is a half-wave plate, oriented as shown by axis 24, then the waveplate may change incident linearly polarized light to polarized light with the direction of polarization rotated by 90 degrees. Consequently, instead of the polarizing sunglasses almost completely blocking the light from the HUD and passing the light from the outside scene as in the prior art, the inventive lens 16 causes light from the HUD to be preferentially passed to the driver relative to the light from the outside scene.

If the waveplate is a quarter-wave plate, oriented as shown by axis 24, then the waveplate may change the incident polarized light into circularly polarized light. Consequently, the polarizing sunglasses may attenuate the light from the outside scene and the light 22 from the HUD to an approximately equal degree, rather than blocking the HUD light more than the outside light, as in the prior art.

If the waveplate is not one of these two special cases of a half-wave plate or a quarter-wave plate, or is not oriented at exactly 45 degrees from the vertical direction, the waveplate may still provide approximately the same functionality.

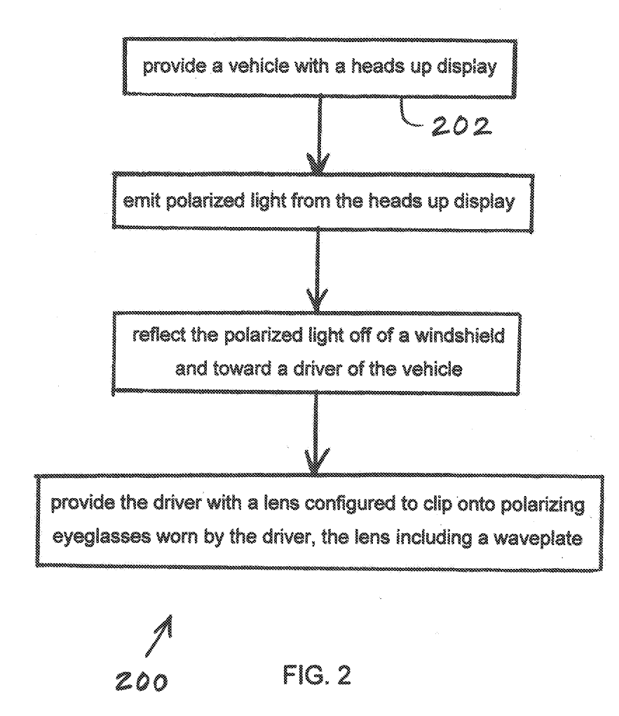

FIG. 2 illustrates one embodiment of an automotive display method 200 of the present invention. In a first step 202, a vehicle is provided with a head up display. For example, a head up display may be installed in the dashboard for projecting a light field onto the windshield. In a next step 204, polarized light is emitted from the head up display. That is, the light field projected from the head up display may include polarized light. Next, in step 206, the polarized light is reflected off of a windshield and toward a driver of the vehicle. For example, the head up display may direct the polarized light in a direction such that the light is reflected off of the windshield and impinges upon the eyes of the driver of the vehicle. In a final step 208, the driver is provided with a lens configured to clip onto polarizing eyeglasses worn by the driver, the lens including a waveplate. For example, clip-on lenses 16 may be clipped onto polarizing eyeglasses 18 worn by driver's head 20, wherein lenses 16 each include a waveplate.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a heads up display module configured to emit polarized light;
a windshield configured to reflect the polarized light toward a driver of the vehicle; and
a lens configured to clip onto polarizing eyeglasses worn by the driver, the lens including a waveplate.

2. The vehicle of claim 1 wherein the waveplate comprises a half-wave plate.

3. The vehicle of claim 2 wherein the half-wave plate is configured to rotate a direction of polarization of the polarized light about 90 degrees.

4. The vehicle of claim 1 wherein the waveplate comprises a quarter-wave plate.

5. The vehicle of claim 4 wherein the quarter-wave plate is configured to change the polarized light into circularly polarized light.

6. The vehicle of claim 1 wherein the waveplate has an axis that is oriented at an angle of about 45 degrees relative to a vertical direction.

7. The vehicle of claim 1 wherein the lens is configured to clip onto an outwardly facing surface of the polarizing eyeglasses worn by the driver.

8. An automotive display method, comprising:
providing a vehicle with a heads up display;
emitting polarized light from the heads up display;
reflecting the polarized light off of a windshield and toward a driver of the vehicle; and
providing the driver with a lens configured to clip onto polarizing eyeglasses worn by the driver, the lens including a waveplate.

9. The method of claim 8 wherein the waveplate comprises a half-wave plate.

10. The method of claim 9 wherein the half-wave plate is configured to rotate a direction of polarization of the polarized light about 90 degrees.

11. The method of claim 8 wherein the waveplate comprises a quarter-wave plate.

12. The method of claim 11 wherein the quarter-wave plate is configured to change the polarized light into circularly polarized light.

13. The vehicle of claim 8 wherein the waveplate has an axis that is oriented at an angle of about 45 degrees relative to a vertical direction.

14. The vehicle of claim 8 wherein the lens is configured to clip onto an outwardly facing surface of the polarizing eyeglasses worn by the driver.

15. A vehicle, comprising:
a heads up display module configured to emit polarized light;
a windshield configured to reflect the polarized light toward a driver of the vehicle; and
a lens configured to be attached to polarizing eyeglasses worn by the driver, the lens including a waveplate having an axis that is oriented at an angle of approximately between 35 degrees and 55 degrees relative to a vertical direction.

16. The vehicle of claim 15 wherein the waveplate comprises a half-wave plate.

17. The vehicle of claim 16 wherein the half-wave plate is configured to rotate a direction of polarization of the polarized light about 90 degrees.

18. The vehicle of claim 15 wherein the waveplate comprises a quarter-wave plate.

19. The vehicle of claim 18 wherein the quarter-wave plate is configured to change the polarized light into circularly polarized light.

20. The vehicle of claim 15 wherein the lens is configured to clip onto an outwardly facing surface of the polarizing eyeglasses worn by the driver.
